(19) United States
(12) Patent Application Publication
(10) Pub. No.: US 2022/0381584 A1
(43) Pub. Date: Dec. 1, 2022

(54) EXTENSIBLE ENVIRONMENTAL DATA COLLECTION PACK

(71) Applicant: GrayWolf Sensing Solutions LLC, Shelton, CT (US)

(72) Inventors: William F. VanWart, Austin, TX (US); Richard T. Stonier, Shelton, CT (US); John Coffey, Annacotty, County Limerick (IE)

(73) Assignee: GrayWolf Sensing Solutions LLC, Shelton, CT (US)

(21) Appl. No.: 17/884,163

(22) Filed: Aug. 9, 2022

Related U.S. Application Data
(63) Continuation-in-part of application No. 15/942,264, filed on Mar. 30, 2018, now abandoned.
(60) Provisional application No. 62/482,774, filed on Apr. 7, 2017.

(51) Int. Cl. G01D 4/00; G06F 5/01

(52) U.S. Cl. CPC G01D 4/002; G06F 5/012

(57) ABSTRACT

An environmental data collection system includes one or more smart sensors, a controller coupled to the one or more smart sensors, the controller including one or more modular decoders having a processor and a memory storing computer readable program code, that when executed by the processor, causes the modular decoder to configure communication and data retrieval between the one or more smart sensors and the controller, perform signal processing on data retrieved from the one or more smart sensors specific to the sensing capabilities of the one or more smart sensors, convert the signal processed data to a fixed bit format, and convey the fixed bit data to the controller.

This application is a continuation in part of U.S. patent application Ser. No. 15/942,264, filed on 30 Mar. 2018, which claims the benefit of U.S. Provisional Application No. 62/482,774, filed on 7 Apr. 2017, incorporated by reference in their entireties.

### FIELD

The disclosed exemplary embodiments are directed to environmental probes and sensors, and in particular, to an extensible environmental data collection pack having a controller, one or more self-configuring smart probes, and a set of smart sensors.

### BACKGROUND

Environmental instruments are capable of measuring various parameters, including amounts of volatile organic compounds, toxic gasses, sound, relative humidity, light, etc. However, while sensors for these different parameters may be smart, that is, may be capable of processing sensor signals to achieve a specific type of output, smart sensors have different form factors, may utilize different communication protocols, and may produce different types of outputs. There is a need for an extensible environmental data collection pack that supports a number of smart sensors and one or more smart probes and overcomes the limitations of the prior art.

### SUMMARY

The disclosed embodiments are directed to a controller, a set of smart sensors, and optionally one or more smart probes. The smart sensors and smart probes, under control of the controller, communicate using a common communication protocol and provide environmental data in a common, normalized format.

The disclosed embodiments are also directed to an environmental data collection system including a controller and one or more smart sensors coupled to the controller, each smart sensor having a memory, the memory configured to store configuration and calibration data for each data channel output by sensing devices of the smart sensors.

The one or more smart sensors may each include a sensor communication interface for communicating with the controller.

The configuration and calibration data may include conditioning information for converting the data channel outputs to a fixed bit format.

The fixed bit format may be a 24 bit format.

The one or more smart sensors may include a signal processor configured to use the configuration and calibration data for processing data from each data channel output of the sensing devices, and to use the conditioning information to convert the sensor data for each data channel output to a fixed bit format.

The signal processor may be an analog to digital converter.

The one or more smart sensors may include a microcontroller configured to use the configuration and calibration data for processing data from each data channel output of the sensing devices, and to use the conditioning information to convert the sensor data for each data channel output to a fixed bit format.

The controller may include a microprocessor and a memory including computer program code, where executing the computer program code by the microprocessor causes the controller to use the configuration and calibration data for processing data from each data channel output of the sensing devices, and to use the conditioning information to convert the sensor data for each data channel output to a fixed bit format.

The environmental data collection system may also include one or more self-configuring smart probes.

The controller may include a communication interface to one or more of a wide area or other network, a cloud service, and a building automation system.

The disclosed embodiments are further directed to a method of collecting environmental data, including using a controller to operate one or more smart sensors, and using a memory on each smart sensor to store configuration and calibration data for each data channel output by sensing devices of each smart sensors.

The one or more smart sensors may each include a sensor communication interface for communicating with the controller.

The configuration and calibration data may include conditioning information for converting the data channel outputs to a fixed bit format.

The fixed bit format may be a 24 bit format.

The method may include using a signal processor of the one or more smart sensors to use the configuration and calibration data for processing data from each data channel output of the sensing devices, and to use the conditioning information to convert the sensor data for each data channel output to a fixed bit format.

The signal processor may be an analog to digital converter.

The method may further include using a microcontroller of the one or more smart sensors to use the configuration and calibration data for processing data from each data channel output of the sensing devices; and to use the conditioning information to convert the sensor data for each data channel output to a fixed bit format.

The controller may include a microprocessor and a memory including computer program code, and the method may further include executing the computer program code by the microprocessor to cause the controller to use the configuration and calibration data for processing data from each data channel output of the sensing devices, and to use the conditioning information to convert the sensor data for each data channel output to a fixed bit format.

The disclosed embodiments are further directed to an environmental data collection system including one or more smart sensors, a controller coupled to the one or more smart sensors, the controller including one or more modular decoders having a processor and a memory storing computer readable program code, that when executed by the processor, causes the modular decoder to configure communication and data retrieval between the one or more smart sensors and the controller, perform signal processing on data retrieved from the one or more smart sensors specific to the sensing capabilities of the one or more smart sensors, convert the signal processed data to a fixed bit format, and convey the fixed bit data to the controller.

The signal processing may include one or more of averaging and median-filtering, calculating time weighted average values, calculating 15-minute short term exposure limit values, calculating dewpoint, and using absolute humidity, wet bulb, specific humidity and humidity ratio to calculate % RH and temperature measurements.

The fixed bit format may be a 24 bit format.

The environmental data collection system may further include a web service, wherein the one or more smart sensors may include calibration circuitry configured to send one or more set points in the form of a calibration signal to a sensing device of the smart sensor, and in response to the calibration signal, the sensing device may operate to output one or more known signals to the smart sensor which, along with the setpoints, are conveyed by the controller to the web service.

The web service may be configured to calculate calibration correction factors based on differences between the one or more known signals and the set points, and convey the calibration correction factors to the microcontroller for calibrating the sensing device.

The web service may include a storage facility configured for storing data including one or more of a current calibration status, calibration schedules, calibration set points, sensing device known signal outputs, and calibration correction factors for the one or more smart sensors, and an alert facility programmed to send electronic communication alerts related to the stored data.

The electronic communication alerts may include one or more of emails, short message service, multimedia service, or text messages.

The disclosed embodiments are still further directed to a method of collecting environmental data including using one or more modular decoders of a controller to: configure communication and data retrieval between one or more smart sensors and the controller; perform signal processing on data retrieved from the one or more smart sensors specific to the sensing capabilities of the one or more smart sensors; convert the signal processed data to a fixed bit format; and convey the fixed bit data to the controller.

The signal processing may include one or more of averaging and median-filtering, calculating time weighted average values, calculating 15-minute short term exposure limit values, calculating dewpoint, and using absolute humidity, wet bulb, specific humidity and humidity ratio to calculate % RH and temperature measurements.

The fixed bit format may be a 24 bit format.

The method may further include using calibration circuitry of the one or more smart sensors to send one or more set points in the form of a calibration signal to a sensing device of the smart sensor and, in response to the calibration signal, causing the sensing device to output one or more known signals to the smart sensor, conveying the one or more known signals and the setpoints to a web service by the controller.

The method may further include using the web service to calculate calibration correction factors based on differences between the one or more known signals and the set points, and convey the calibration correction factors to the microcontroller for calibrating the sensing device.

The method may further include using the web service to store data including one or more of a current calibration status, calibration schedules, calibration set points, sensing device known signal outputs, and calibration correction factors for the one or more smart sensors, and send electronic communication alerts related to the stored data.

The electronic communication alerts may include one or more of emails, short message service, multimedia service, or text messages.

### BRIEF DESCRIPTION OF THE DRAWINGS

FIG. 1 shows a schematic illustration of an exemplary extensible environmental data collection pack 100 according to the disclosed embodiments; and

FIG. 2 shows an exemplary block diagram of a controller according to the disclosed embodiments;

FIGS. 3A, 3B, and 4 shows schematic illustrations of general embodiments of smart sensors according to the present disclosure;

FIG. 5 shows a schematic illustration of an exemplary sound level smart sensor according to the disclosed embodiments; and

FIG. 6 shows a schematic illustration of an exemplary particle matter smart sensor according to the disclosed embodiments;

FIG. 7 shows a schematic illustration of an exemplary electrochemical smart sensor according to the disclosed embodiments;

FIG. 8 shows a schematic illustration of an exemplary lux smart sensor according to the disclosed embodiments;

FIG. 9 shows a schematic illustration of an exemplary smart probe according to the disclosed embodiments;

FIG. 10 shows an exemplary smart sensor system with an enhanced calibration capability;

FIG. 11 illustrates an example of a smart sensor for use with the enhanced calibration capability; and

FIG. 12 depicts a diagram of an exemplary modular decoder according to the disclosed embodiments.

### DETAILED DESCRIPTION

The aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

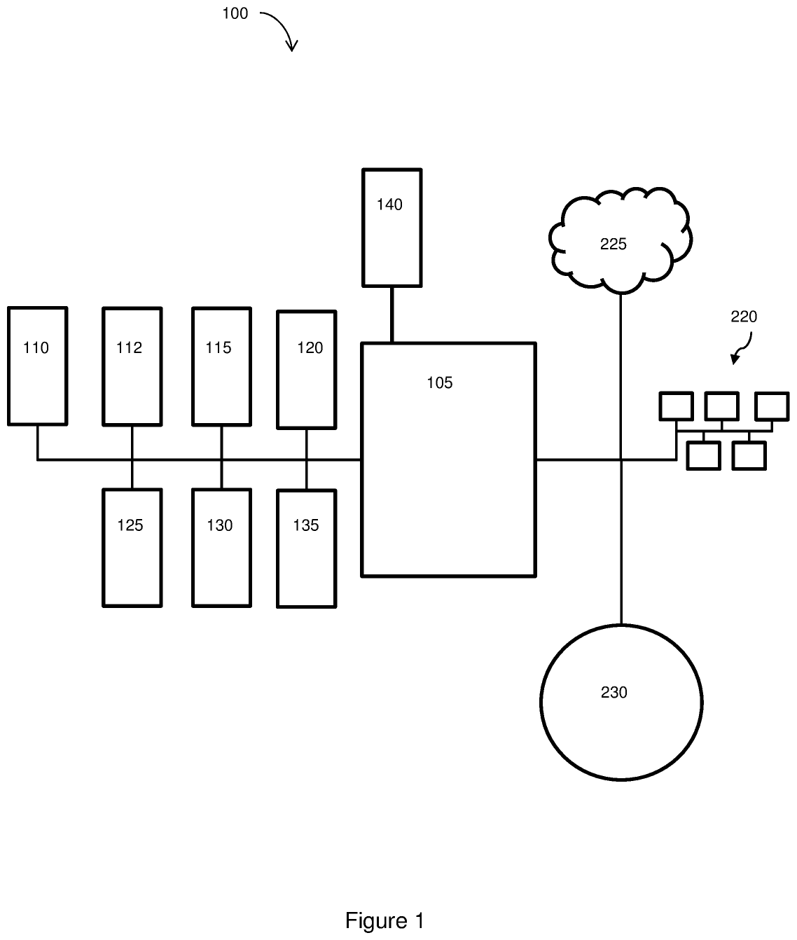

FIG. 1 shows a schematic illustration of an exemplary system 100 according to the disclosed embodiments. The system 100 may include at least one controller 105, one or more smart sensors 110, 112, 115, 120, 125, 130, 135 and optionally one or more smart probes 140. The controller 105 may be connected to one or more of a wide area or other network 220, a web service 225, which may in the form of a cloud service, and a building automation system 230. Additionally, the system 100, could be connected to another system 100 with the same or different configuration of smart sensors and smart probes. In some embodiments, an exemplary system 100 may be referred to as a “pack” to indicate that the controller 105, any sensors, and the smart probe, if present, operate as a unit.

It should be understood that system 100 may have any number of configurations. For example, in a first configuration, the system 100 may include a particulate matter smart sensor 125, described below, the controller 105, and a smart probe 140. In a second configuration, the system 100 may include a sound level smart sensor 120, described below, the controller 105, and a smart probe 140. In a third configuration, the system may include a lux smart sensor, described below, the controller 105, and a smart probe. It should also be understood that multiple systems 100 may operate independently or may be linked together with one of the linked systems operating as a master controller.

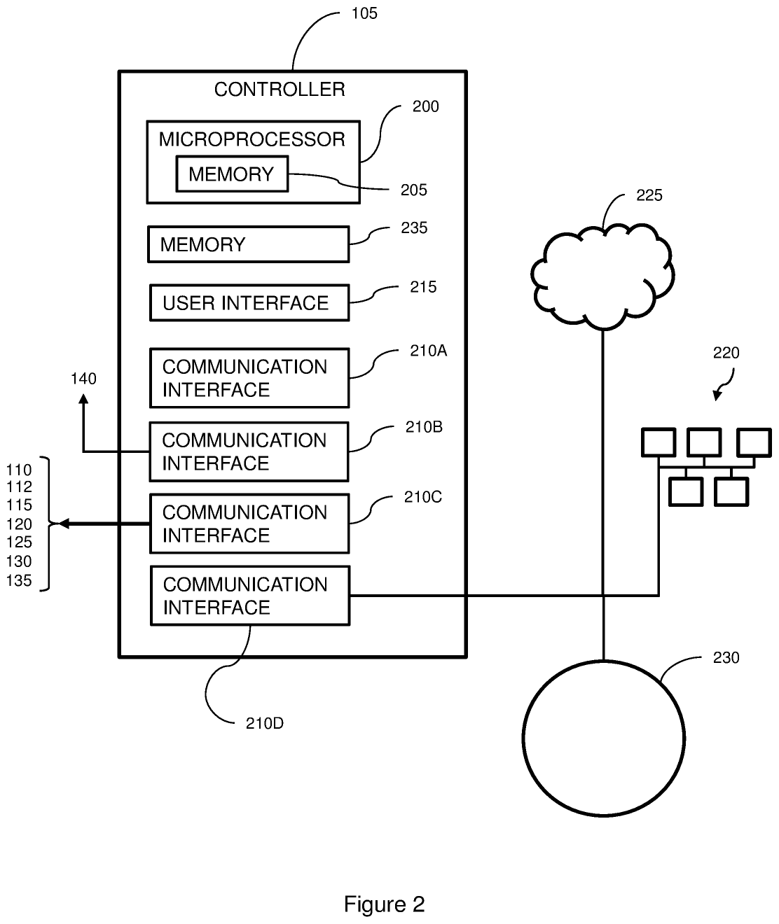

FIG. 2 shows an exemplary block diagram of the controller 105. The controller 105 may include a microprocessor 200 with memory 205 which may be onboard or embedded, a number of communication interfaces 210A, 210B, 210C, 210D, a user interface 215, and an external memory 235.

The microprocessor 200 may be implemented using any suitable computing device, for example, a microcontroller or a Computer On Module (COM). The microprocessor 200 may include flash memory, non-volatile memory, internal registers, and a plurality of I/O lines, and may be capable of running an operating system such as Windows Embedded, LINUX, Android, or any other suitable operating system.

The onboard or embedded memory 205 may include magnetic media, semiconductor media, optical media, or any media which is readable by the microprocessor 200 and may store computer readable program code, that when executed by the microprocessor 200, causes the controller to carry out and perform the processes described herein. The onboard or embedded memory 205 may also store programs for the microprocessor 200 and for controllers that may be utilized on the individual smart sensors 110, 115, 120, 125, 130, 135 and the smart probe 140, and configuration data for the smart sensors 110, 112, 115, 120, 125, 130, 135 and the smart probe 140. The controller 105 may be operable to receive data from the smart sensors 110, 112, 115, 120, 125, 130, 135 and smart probe 140 and store the data in the onboard or embedded memory 205. The controller 105 may also be operable to receive audio and text notes, documents, and video information through the user interface 215 and communication interfaces, e.g. 210D, and store them in the onboard or embedded memory 205.

The communication interfaces 210A, 210B, 210C, 210D may include one or more of a WiFi (IEEE 802.11) wireless interface, a Bluetooth (IEEE 802.15) wireless interface, a Universal Serial Bus (USB) interface, an RS 232 serial communication interface, a Modbus interface, or any other communication interface suitable for transmitting, receiving, or exchanging data. At least one of the communication interfaces, for example, communication interface 210C, may provide a communication path to the one or more smart sensors 110, 112, 115, 120, 125, 130, 135. At least one of the communication interfaces, for example, communication interface 210B, may provide a communication path to the smart probe 140. Furthermore, at least one of the communication interfaces, for example, communication interface 210D, may provide a communication path to one or more of a wide area or other network 220, a web service 225, and a building automation system 230, any of which may provide programming, data, and other information to the controller 105. In one or more embodiments, the network 220 or web service 225 may provide programs, parameters and other data for configuring the smart sensors 110, 112, 115, 120, 125, 130, 135, the smart probe 140, or both. In some embodiments, the controller 105 may send data from one or more of the smart sensors 110, 112, 115, 120, 125, 130, 135 and the smart probe 140 to any of the network 220, a web service 225, and building automation system 230.

The user interface 215 may include any number of input and output devices including those which may operate to allow input to the controller 105 and provide output from the controller 105. For example, the user interface 215 may include a keyboard and a microphone for entering commands and data, and a display and speaker for providing information to a user. The user interface 215 may be capable of providing the contents of the onboard or embedded memory 205 to a user, including for example, displaying the programs for the microprocessor 200 and for the smart sensor and smart probe controllers, data from the smart sensors 110, 112, 115, 120, 125, 130, 135 and smart probe 140, and displaying or playing any of the stored audio and text notes, documents, and video information. In at least one embodiment, the user interface 215 may include a liquid crystal or light emitting diode display. In some embodiments, the display may be a touch sensitive display to allow input directly through the display. Some embodiments of the controller 105 may be configured without a user interface 215 and may exchange information through the communication interface 210D.

The external memory 235 may also include magnetic media, semiconductor media, optical media, or any media which is readable by the microprocessor 200 and may store configuration and calibration data that may be specific to the types of smart sensors 110, 112, 115, 120, 125, 130, 135 and the configuration of the smart probe 140. The external memory 235 may also store logged data collected from the smart sensors 110, 115, 120, 125, 130, 135 and the smart probe 140, which may be provided to a user or downloaded to any of the network 220, web service 225, and building automation system 230.

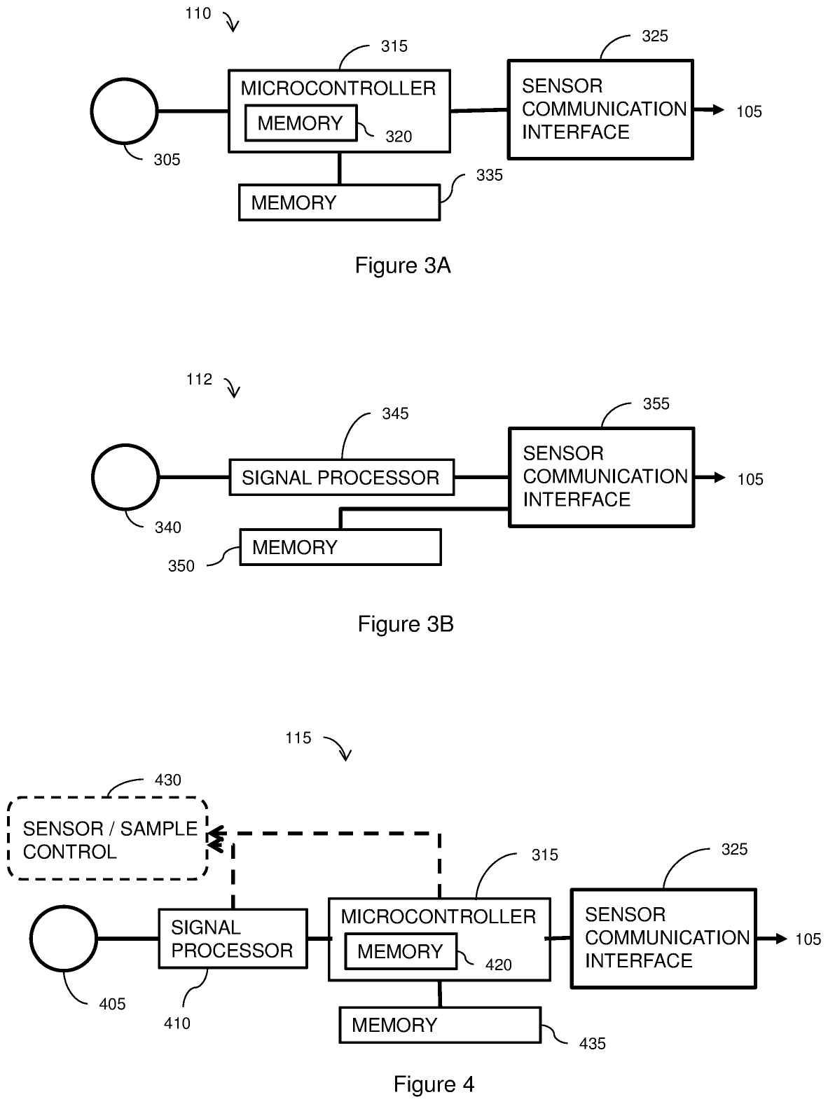

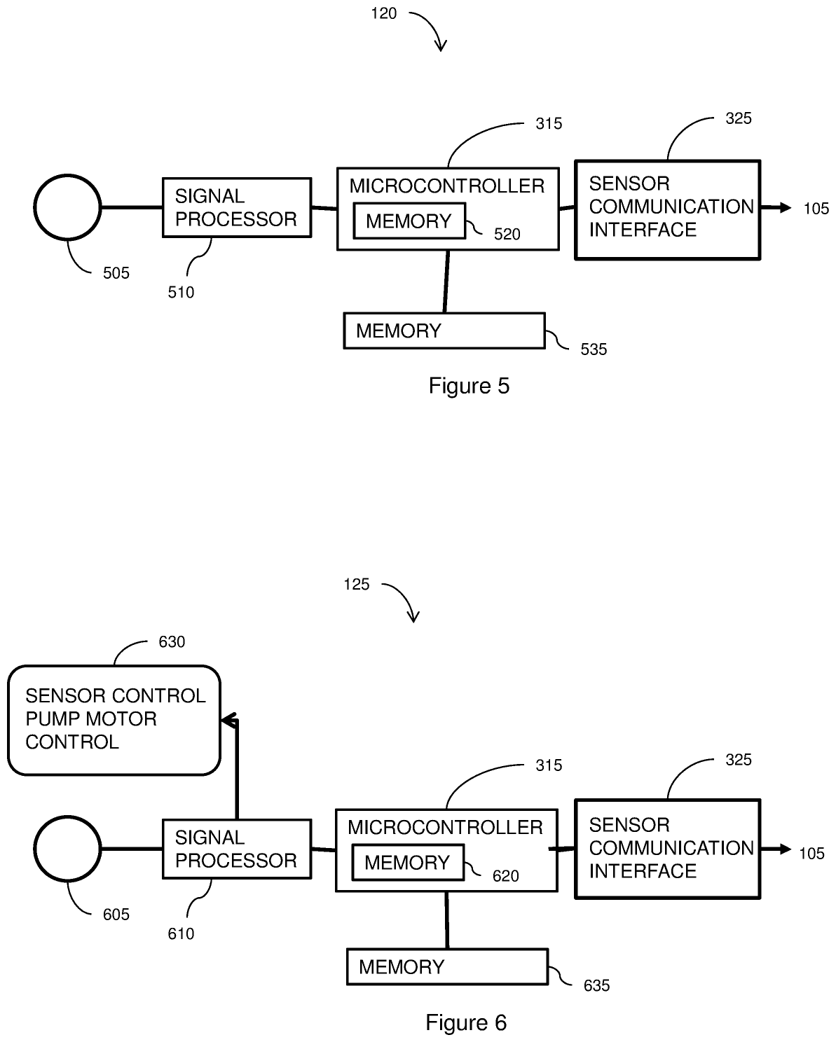

FIGS. 3A, 3B, and 4 illustrate general embodiments 110, 112, 115 of the smart sensors according to the present disclosure, while FIGS. 5-8 illustrate exemplary smart sensors 120, 125, 130, 135 for specific applications.

FIG. 3A shows an exemplary smart sensor 110. The smart sensor 110 may include a sensing device 305, microcontroller 315 with on board or embedded memory 320, and a sensor communication interface 325. The sensing device 305 may include any suitable environmental sensor that provides a digital output that, if required, may be processed directly by the microcontroller 315. The onboard or embedded memory 320 may include programming information for causing the microcontroller 315 to control the operation of the sensing device, to process the data from the sensing device 305, and to convert the data to a common format, for example, having a fixed number of bits. Some embodiments may utilize a normalized 24 bit format.

The smart sensor 110 may also include an external memory 335 with specific addresses or memory blocks for storing configuration and calibration data, for example, the status of components of the smart sensor, for example, a power status and battery level, a model number, an amount of time since power on, a type of electronics present on board, the particular sensing capabilities, and the available operational memory in external memory 335. The external memory 335 may also include specific addresses for storing configuration data about the smart sensor 110, for example, sensing device names, serial numbers, and install dates, sensing device calibration data, constants, set points, calibration location, calibration date, calibration technician, the number of data channels returned by the sensing device 305, and characteristics of each data channel, such as sensing technology, sensor type, serial numbers, and data encoding techniques. The configuration and calibration data may also include a code, algorithm, or other conditioning information for converting the output of the data channels to a fixed number of bits. The external memory 335 may also store the time as updated by a real time clock and the status of peripheral devices, such as pumps, fans, and communication network interfaces.

The microcontroller 315 may be implemented using any suitable computing device, for example, a RISC single chip microcontroller with a modified Harvard architecture, and on board flash memory. The sensor communication interface 325 may include one or more of a Universal Serial Bus (USB) interface, an RS 232 serial communication interface, an Inter-Integrated Circuit (I²C) bus interface, a Modbus interface, or any other wired communication interface suitable for transmitting, receiving, or exchanging data.

FIG. 3B shows another exemplary smart sensor 112. The smart sensor 112 may include a sensing device 340, a signal processor 345, an external memory 350 with the specific addresses or memory blocks for storing the configuration and calibration data as described above for external memory 335, and a sensor communication interface 325. In this embodiment, the signal processor 345 and external memory 350 may be accessible by the controller 105 through the sensor communication interface 325.

The sensing device 340 may include any suitable environmental sensor, for example, a sound sensing element, a laser detector, Pt100 or other sensor, capacitive or other % RH sensor, PID or other sensor for volatile organic compounds, pellister or other sensor for LEL/flammables, colorimetric/photometric sensor, NDIR, electrochemical sensor, or light sensor. In some embodiments, the sensing device 340 may provide an analog current or voltage output, while in other embodiments the sensing device 340 may provide a digital output. The signal processor 345 may include one or more of any suitable processing functions, for example, a digital signal processor, a digital or analog filtering function, a digits or analog scaling function, an averaging function, an amplifier, a counter, and an A/D converter. The signal processor 345 may generally output data in a common format, for example, a fixed bit format, and as a further example, a normalized 24 bit representation of the output of the sensing device 340.

FIG. 4 shows yet another exemplary smart sensor 115. The smart sensor 115 may include a sensing device 405, a signal processor 410, a microcontroller 315 with on board or embedded memory 420, and a sensor communication interface 325. The exemplary smart sensor 115 may optionally include control circuitry 430 for controlling the sensing device 405, for example, by setting a sensor sampling rate.

The sensing device 405 may include any suitable environmental sensor, for example, a sound sensing element, a laser detector, Pt100 or other sensor, capacitive or other % RH sensor, PID or other sensor for volatile organic compounds, pellister or other sensor for LEL/flammables, colorimetric/photometric sensor, NDIR, electrochemical sensor, or light sensor. In some embodiments, the sensing device 405 may provide an analog current or voltage output, while in other embodiments, the sensing device 405 may provide a digital output. The signal processor 410 may include one or more of any suitable processing functions, for example, a digital signal processor, a digital or analog filtering function, a digits or analog scaling function, an averaging function, an amplifier, a counter, and an A/D converter. The onboard or embedded memory 420 may include programming information for causing the microcontroller 315 to control the operation of the signal processor to process data specific to the particular sensing device, to further process the data from the signal processor 410 and to convert the data to a common format, for example, a fixed bit format, or a normalized 24 bit representation. The smart sensor 115 may also include an external memory 435 with the specific addresses or memory blocks for storing the configuration and calibration data as described above for external memory 335.

The smart sensors of the disclosed embodiments may include one or more sound level sensors, particle matter detectors, electrochemical sensors, lux sensors, Photo-Ionization Detector (PID) sensors, CO₂ Non-Dispersive Infra-Red (NDIR) sensors, sensor for flammables, Colorimetric/Photometric sensors and any other environmental sensors that may measure relative humidity, temperature, or barometric pressure, light, radiation, sound, combustible gas or solvents, and any other suitable environmental parameters.

FIG. 5 shows an implementation of a sound level smart sensor 120. In this embodiment, the sensing device may be a sound sensing element 505, for example, a microphone. The signal processor 510 may include an amplifier, a filter, and an A/D converter. The on board or embedded memory 520 may include programs and instructions that cause the processor 315 to control the operation of the signal processor 510, including the amplifier, filter, and A/D converter, to process data specific to the sound sensing element 505, to further process the data from the signal processor 510, and to convert the data to a fixed bit format such as the normalized 24 bit format mentioned above.

Similar to the other smart sensors described herein, the smart sensor 120 may also include an external memory 535 with the specific addresses or memory blocks for storing the configuration and calibration data as described above for external memory 335.

FIG. 6 shows an implementation of a particle matter smart sensor 125. In this embodiment, the sensing device 605 may include be a chamber through which air flows, an air flow sensor, and a laser directed through the air flow. Particles in the air flow may reflect the laser and the reflections may be measured by a detector. The signal processor 610 may analyze the output of the detector to determine particle numbers and/or sizes and/or mass. The on board or embedded memory 620 may include programs and instructions that cause the processor 315 to control the operation of the signal processor 610, including the analysis function of the signal processor, to process data specific to the sensing device 605, to further process the data from the signal processor 610, and to convert the data to a fixed bit format such as the normalized 24 bit format. The external memory 635 may include the specific addresses or memory blocks for storing the configuration and calibration data as described above for external memory 335. The control circuitry 630 may receive signals from the signal processor 610 to control a pump regulating the air flow, the air flow sensor, the laser, and the detector.

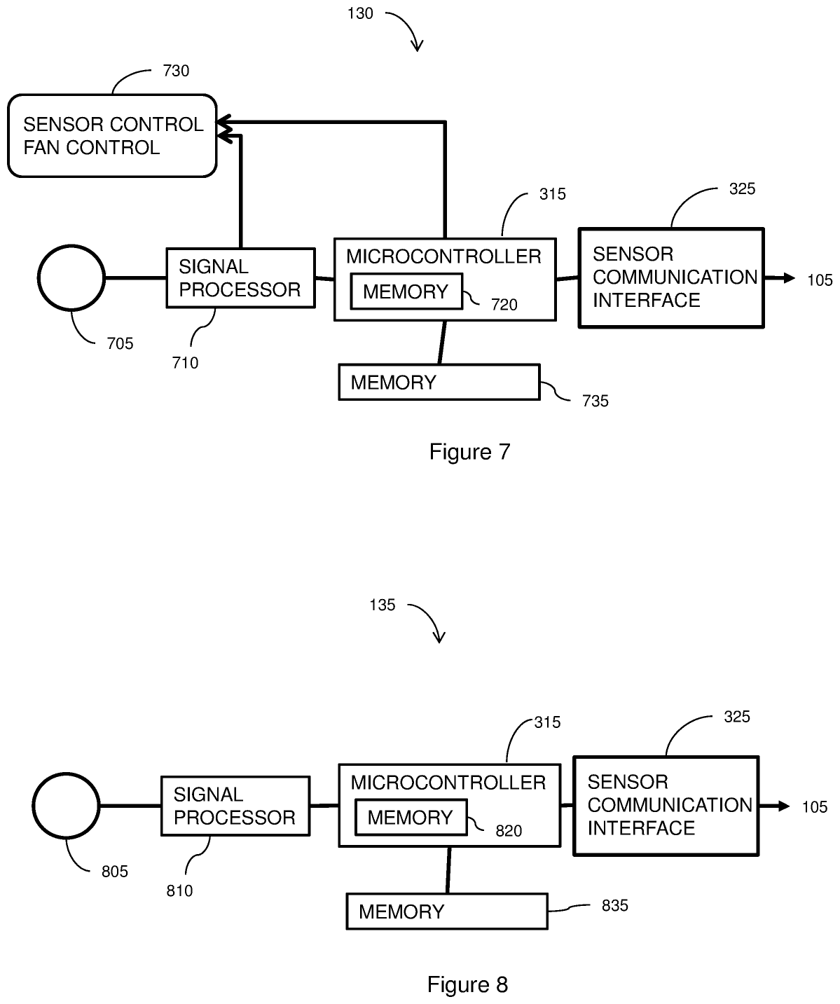

FIG. 7 shows an implementation of an electrochemical smart sensor 130. In this embodiment, the sensing device may be one or more gas sensors 705 for any number of target gasses, or may include other suitable environmental sensors. The signal processor 710 may include an amplifier and an A/D converter. The on board or embedded memory 720 may include programs and instructions that cause the processor 315 to control the operation of the amplifier, A/D converter, and any other function of the signal processor 710, to process gas sensor specific data, to further process the data from the signal processor 610, and to convert the data to a fixed bit format.

The electrochemical smart sensor 130 may also include an external memory 735 with the specific addresses or memory blocks for storing the configuration and calibration data as described above for memory 335.

FIG. 8 shows an implementation of a lux smart sensor 135. In this embodiment, the sensing device 805 may be one or more light sensors, for example, infrared and visible light. The signal processor 810 may include an A/D converter. The on board or embedded memory 820 may include programs and instructions that cause the processor 315 to control the operation of the A/D converter, and any other function of the signal processor 810, to process light sensor specific data, to further process the data from the signal processor 810, and to convert the data to a fixed bit format. Similar to the other smart sensors of the disclosed embodiments, the external memory 835 may also include the specific addresses or memory blocks for storing the configuration and calibration data as described above for external memory 335.

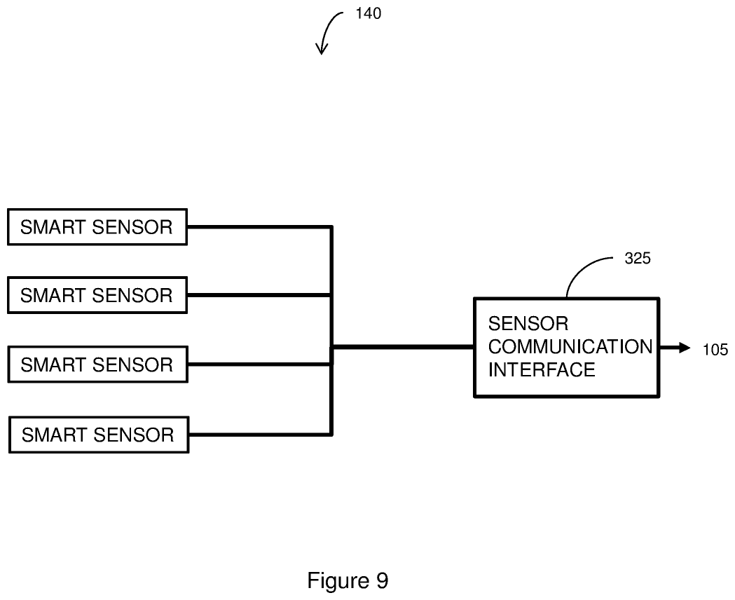

FIG. 9 shows a schematic illustration of an exemplary smart probe 140 connected to the controller 105. The smart probe may be a self-configuring smart probe as disclosed in U.S. patent application Ser. No. 15/788,144, filed 19 Oct. 2017, incorporated by reference in its entirety, and may include one or more smart sensors as described herein, or any other suitable environmental sensors. Similar to the smart sensors, the smart probe 140 may provide data to the controller 105 in a fixed bit format.

In operation, the controller 105 polls the smart sensors 110, 112, 115, 120, 125, 130, 135 and the smart probe 140 and receives information about each smart sensor and the smart probe, including the information at the specific addresses or memory blocks. The controller may enable the operation of each smart sensor and the smart probe, collect data, and display the data and may also send the data to one or more of the wide area or other network 220, the web service 225, and the building automation system 230.

In some embodiments, upon the controller 105 enabling the smart sensors 110, 112, 115, 120, 125, 130, 135, each of the microcontrollers 315 may poll their respective external memories 335, 435, 535, 635, 735, 835 and retrieve characteristics of data channels returned by the respective sensing devices, for example, the sensing technologies and sensor types. The microcontrollers may also retrieve a code, algorithm, or other conditioning information for converting the output of the respective sensing devices 305, 405, 505, 605, 705, 805 to a fixed bit format. The microcontrollers 315 may use that conditioning information to convert the respective sensing device channel outputs to the fixed bit format, and may transit the fixed bit format data to the controller 105.

In additional embodiments, upon the controller 105 enabling the smart sensors 110, 112, 115, 120, 125, 130, 135, each of the microcontrollers 315 may poll their respective external memories 435, 535, 635, 735, 835 and retrieve characteristics of data channels returned by the respective sensing devices, for example, the sensing technologies and sensor types. The microcontrollers may also retrieve a code, algorithm, or other conditioning information for converting the outputs of the respective signal processors 410, 510, 610, 710, 810 to a fixed bit format. The controllers may use that conditioning information to convert the respective signal processor outputs for each channel to the fixed bit format, and may transmit the fixed bit format data to the controller 105.

In further embodiments, upon the controller enabling the smart sensors 110, 112, 115, 120, 125, 130, 135, the controller 105 may poll each external memory 335, 350, 435, 535, 635, 735, 835 and retrieve characteristics of data channels returned by the respective sensing devices, for example, the sensing technologies and sensor types. The controller may also retrieve a code, algorithm, or other conditioning information for converting the channel outputs of the respective sensing devices 305, 340, 405, 505, 605, 705, 805 to a fixed bit format. The controller may then poll the enabled smart sensors for the outputs of their respective sensor device outputs, and may use the respective conditioning information to convert the respective sensing device outputs as received to the fixed bit format for further processing and analysis.

While the disclosed embodiments are described in the context of converting the sensing device output, the signal processor output, or both to a 24 bit output, it should be understood that the respective outputs may be utilized as is with no conditioning or may be converted to any other format suitable for use according to the disclosed embodiments.

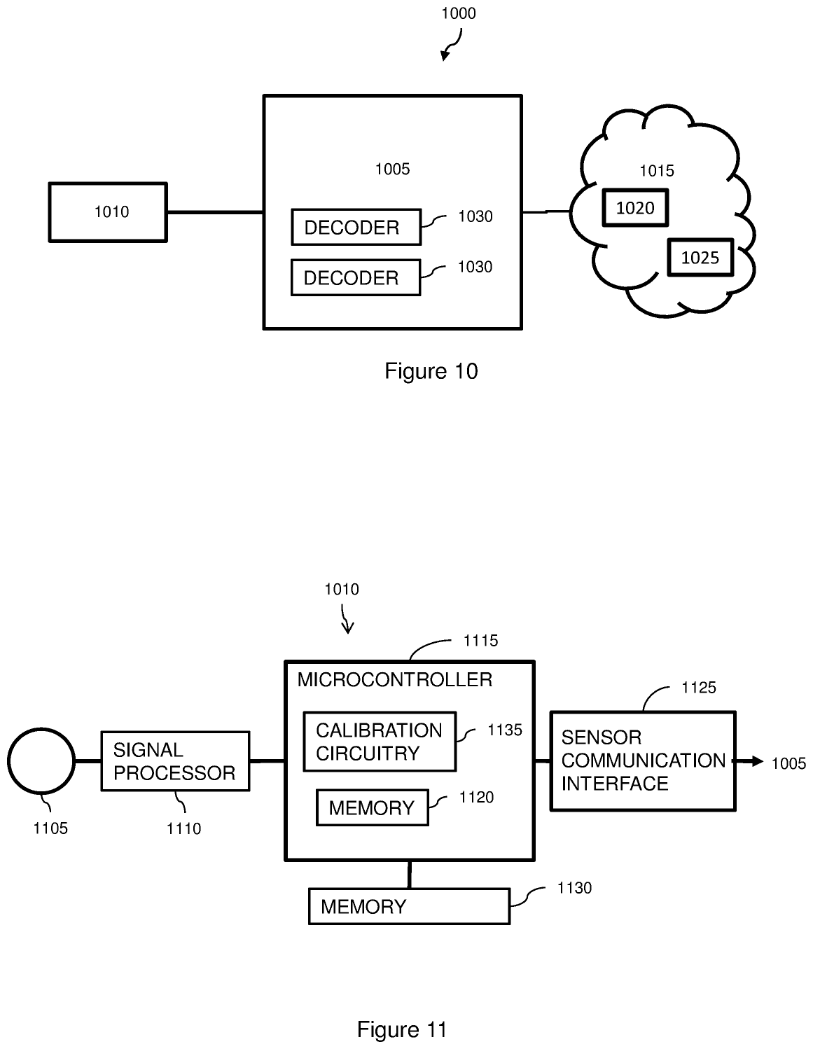

FIG. 10 shows an exemplary smart sensor system 1000 with an enhanced calibration capability. The system 1000 may include at least one controller 1005 and one or more smart sensors 1010. The controller 1005 may have all the capabilities of controller 105 in addition to the capabilities disclosed herein, and the smart sensor 1010 may have all the capabilities of smart sensors 110, 112, 115, 120, 130, 135 in addition to the capabilities described herein. The controller 1005 may be connected to a web service 1015 which may be in the form of a cloud service or other network that provides an external calibration facility. It should be understood that the web service 1015 may have all the capabilities of web service 225 in addition to the capabilities described herein. The controller 1005 may also be programmed to request data from the one or more smart sensors 1010 and forward the data to any suitable remote facility, for example, the web service 1015.

FIG. 11 illustrates an example of the smart sensor 1010 for use in the system with enhanced calibration capability that includes an exemplary sensing device 1105, a signal processor 1110, a microcontroller 1115 with a memory 1120, and a sensor communication interface 1125 coupled to the controller 1005. The smart sensor 1010 may also include an external memory 1130 with specific addresses or memory blocks for storing configuration, calibration, or any other suitable data.

The exemplary sensing device 1105 may be capable of measuring one or more of % RH, Temperature (air/surface/liquid), Dewpoint, Absolute Humidity, Wet bulb, Specific Humidity, Humidity Ratio, Air Velocity, Volume Air Flow, CFM, Differential Pressure, Barometric Pressure, Particle Counts, Particulate Concentration (example PM 2.5 in ug/m3), Sulfur Dioxide (SO2), Nitrogen Dioxide (NO2), Nitric Oxide (NO), Carbon Monoxide (CO), Hydrogen Sulfide (H2S), Hydrogen Cyanide (HCN), Hydrogen Chloride (HCl), Hydrogen Fluoride (HF), Ethylene Oxide (C2H4O), Chlorine Dioxide (ClO2), Carbon Dioxide (CO2), Diborane (B2H6), Ozone (O3), Oxygen (O2), Ammonia (NH3), Chlorine (Cl2), Hydrogen (H2), Fluorine (F2), Formaldehyde (HCHO), Phosphine (PH3), Arsine (AsH3), Silane (SiH4), Phosgene (COCl2), and Total Volatile Organic Compounds (TVOCs).

The microcontroller may have all the capabilities of microcontroller 315 and may further include calibration circuitry 1135. The calibration circuitry 1135 may be implemented as a separate circuit with hardware, for example, a processor, memory, and other circuitry for performing the functions described herein, or may be implemented as part of the program code stored in memory 1120 and executed by microcontroller 1115.

The calibration circuitry may be activated by the controller 1005 on a schedule determined during manufacture, activated by a user, or activated by the web service 1015. Once activated, the calibration circuitry 1135 sends one or more set points in the form of a calibration signal to the sensing device 1105 that causes the sensing device to 1105 to output one or more known signals in the form of currents, voltages, digital outputs, or any suitable measurable outputs, to the signal processor 1110. The set points may be stored in the calibration circuitry 1135 or the memory 1120. The signal processor 1110 may include one or more of any suitable processing functions, for example, a digital signal processor, a digital or analog filtering function, a digits or analog scaling function, an averaging function, an amplifier, a counter, and an A/D converter. When the calibration circuitry 1135 is activated, the signal processor 1110 may generally output data from the sensing device 1105 in the form of A/D counts, which are conveyed by the microcontroller with the set points to the web service 1015 through the sensor communication interface 1125 and the controller 1005.

Upon receiving the set points and the data output by the sensing device 1105, the web service 1015 may operate to compare the data output to the set points and calculate calibration correction factors based on differences between them. The web service 1015 may then convey the calibration correction factors to the microcontroller 1115 through the controller 1005 and the sensor communication interface 1125. The calibration circuitry 1136, the signal processor 1110, or the microcontroller may use the calibration correction factors to calibrate the output of the sensing device 1105.

The web service 1015 may have all the capabilities of the cloud service 225 described above, and may further include programs, parameters and other data for configuring the sensing device 1105. The web service 1015 may also include a storage facility 1020 for storing data including the current calibration status, calibration schedules, and calibration set points, corresponding A/D counts, and calibration correction factors for each calibration date and time, for any number of sensing devices 1105 connected to any number of controllers 1005, and may make the stored data available to authorized users. As a result, the stored data may be monitored by users, such as technical support personnel, remote from the smart sensor system 1000, and may aid in providing technical support without having to physically visit the smart sensor system 1000.

The web service 1015 may further include an alert facility or capability 1025, which may be programmed to send electronic communication alerts related to any of the stored data. For example, the web service 1015 may be programmed to send alerts periodically that include any of the stored data.

As other examples, alerts may also be sent in the event of changes in current calibration status, calibration schedules, and calibration set points, corresponding A/D counts, and calibration correction factors for each calibration date and time. Alerts may be configured to be sent if any of the stored data exceeds or fails to meet a predefined threshold value. Alerts may also be sent each time a calibration is performed, for any errors, such as a sensing device outputting a signal drifting below zero, or for any other user defined reason.

The electronic communication alerts may include one or more of emails, short message service, multimedia service, or text messages, or any suitable electronic communication method.

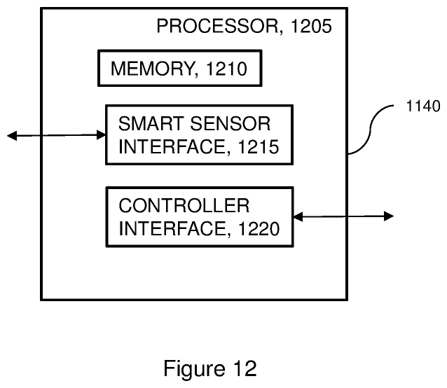

Referring again to FIG. 10, the controller 1005 may include one or more modular sub-microcontroller decoders 1030 that may perform one or more of the functions described herein. A diagram of an exemplary modular decoder 1030 is shown in FIG. 12. The modular decoder 1030 may include a processor 1205 with memory 1210 which may be onboard or embedded, an interface 1215 for communicating with one or more smart sensors 110, 112, 115, 120, 125, 130, 135, 1010, and an interface 1220 for communicating with the controller. The processor 1205 may be implemented using any suitable computing device, for example, a multicore CPU or any other suitable device. The memory 1210 may include magnetic media, semiconductor media, optical media, or any media which is readable by the processor 1205 and may store computer readable program code, that when executed by the processor 1200, causes the modular decoder 1140 to carry out and perform various processes as described herein. In some embodiments, the modular decoder 1030 may optionally be implemented as part of the computer readable program code stored in memory 205 or 235 executed by microprocessor 200.

The modular decoder memory 1210 may be programmed or loaded with computer readable program code from a remote source, for example, the web service 1015, that when executed by processor 1205, operates the modular decoder 1140 to configure the smart sensor interface 1215 to communicate with any of the smart sensors 110, 112, 115, 120, 125, 130, 135, 1010 and retrieve data from any of the smart sensors using one or more of a Bluetooth®, Bluetooth® Low Energy, I²C, ModBus, RS 232, Serial Peripheral Interface (SPI), USB, or any other suitable protocol.

The decoder 1030 may be programmed to perform any suitable data processing functions. For example, the computer readable program code may also operate the modular decoder 1140 to process data from the smart sensors 110, 112, 115, 120, 125, 130, 135, 1010, for example, to perform signal processing such as averaging and median-filtering, calculate 8 hour Time Weighted Average (TWA) and 15-minute Short Term Exposure Limit (STEL) values, and calculate Dewpoint, Absolute Humidity, Wet bulb, Specific Humidity and Humidity Ratio to % RH and Temperature measurements.

The computer readable program code may also operate the modular decoder 1140 to convert data from the smart sensors 110, 112, 115, 120, 125, 130, 135, 1010 to a common format and the configure the controller interface 1220 to communicate with the controller using a serial communication protocol, for example, RS 232 or SPI.

In another embodiment, the decoder 1030 may be specifically programmed to operate a solenoid in conjunction with at least 2 differential pressure smart sensors 1010 to provide auto-zeroing and auto-ranging differential pressure readings; a barometric pressure smart sensor 1010, and two temperature sensing smart sensors. The decoder 1030 may operate to consolidate data from the smart sensors and provide differential pressure data, barometric pressure data, and 2 channels of temperature data to the controller 1005 in the same unified format described above.

Various modifications and adaptations may become apparent to those skilled in the relevant arts in view of the foregoing description, when read in conjunction with the accompanying drawings. However, all such and similar modifications of the teachings of the disclosed embodiments will still fall within the scope of the disclosed embodiments.

Various features of the different embodiments described herein are interchangeable, one with the other. The various described features, as well as any known equivalents can be mixed and matched to construct additional embodiments and techniques in accordance with the principles of this disclosure.

Furthermore, some of the features of the exemplary embodiments could be used to advantage without the corresponding use of other features. As such, the foregoing description should be considered as merely illustrative of the principles of the disclosed embodiments and not in limitation thereof.

1. An environmental data collection system comprising:
one or more smart sensors;
a controller coupled to the one or more smart sensors, the controller including:
one or more modular decoders having a processor and a memory storing computer readable program code, that when executed by the processor, causes the modular decoder to:
configure communication and data retrieval between the one or more smart sensors and the controller;
perform signal processing on data retrieved from the one or more smart sensors specific to the sensing capabilities of the one or more smart sensors;
convert the signal processed data to a fixed bit format; and
convey the fixed bit data to the controller.

2. The environmental data collection system of claim 1, wherein the signal processing includes one or more of averaging and median-filtering, calculating time weighted average values, calculating 15-minute short term exposure limit values, calculating dewpoint, and using absolute humidity, wet bulb, specific humidity and humidity ratio to calculate % RH and temperature measurements.

3. The environmental data collection system of claim 1, wherein the fixed bit format is a 24 bit format.

4. The environmental data collection system of claim 1, further comprising:
a web service;
wherein the one or more smart sensors comprise calibration circuitry configured to send one or more set points in the form of a calibration signal to a sensing device of the smart sensor, and
wherein, in response to the calibration signal, the sensing device operates to output one or more known signals to the smart sensor which, along with the setpoints, are conveyed by the controller to the web service.

5. The environmental data collection system of claim 4, wherein the web service is configured to:
calculate calibration correction factors based on differences between the one or more known signals and the set points; and
convey the calibration correction factors to the microcontroller for calibrating the sensing device.

6. The environmental data collection system of claim 4, wherein the web service comprises:
a storage facility configured for storing data including one or more of a current calibration status, calibration schedules, calibration set points, sensing device known signal outputs, and calibration correction factors for the one or more smart sensors; and
an alert facility programmed to send electronic communication alerts related to the stored data.

7. The environmental data collection system of claim 6, wherein the electronic communication alerts include one or more of emails, short message service, multimedia service, or text messages.

8. A method of collecting environmental data, comprising:
using one or more modular decoders of a controller to:
configure communication and data retrieval between one or more smart sensors and the controller;
perform signal processing on data retrieved from the one or more smart sensors specific to the sensing capabilities of the one or more smart sensors;
convert the signal processed data to a fixed bit format; and
convey the fixed bit data to the controller.

9. The method of claim 8, wherein the signal processing includes one or more of averaging and median-filtering, calculating time weighted average values, calculating 15-minute short term exposure limit values, calculating dewpoint, and using absolute humidity, wet bulb, specific humidity and humidity ratio to calculate % RH and temperature measurements.

10. The method of claim 8, wherein the fixed bit format is a 24 bit format.

11. The method of claim 8, further comprising:
using calibration circuitry of the one or more smart sensors to send one or more set points in the form of a calibration signal to a sensing device of the smart sensor, and
and, in response to the calibration signal, causing the sensing device to output one or more known signals to the smart sensor; and
conveying the one or more known signals and the setpoints to a web service by the controller.

12. The method of claim 11 further comprising using the web service to:
calculate calibration correction factors based on differences between the one or more known signals and the set points; and
convey the calibration correction factors to the microcontroller for calibrating the sensing device.

13. The method of claim 11, further comprising using the web service to:
store data including one or more of a current calibration status, calibration schedules, calibration set points, sensing device known signal outputs, and calibration correction factors for the one or more smart sensors; and
send electronic communication alerts related to the stored data.

14. The method of claim 13, wherein the electronic communication alerts include one or more of emails, short message service, multimedia service, or text messages.
